(19) United States
(12) Patent Application Publication
(10) Pub. No.: US 2017/0241334 A1
(43) Pub. Date: Aug. 24, 2017

(54) INTEGRATED LINEAR PARALLEL HYBRID ENGINE

(71) Applicant: Maglev Motors, Inc., Boulder, CO (US)

(72) Inventors: Gebin Maxey, Boulder, CO (US); John Bohlmann, Boulder, CO (US)

(73) Assignee: Maglev Motors, Inc., Boulder, CO (US)

(21) Appl. No.: 15/049,344

(22) Filed: Feb. 22, 2016

(51) Int. Cl. F02B 75/40; H02K 3/04; H02K 33/12; H02K 7/00; H02K 7/075; H02K 1/34; H02K 11/33

(52) U.S. Cl. CPC F02B 75/40; H02K 1/34; H02K 3/04; H02K 11/33; H02K 7/006; H02K 7/075; H02K 33/12; F02B 61/00

(57) ABSTRACT

An integrated linear parallel hybrid engine is described. Embodiments of the integrated parallel hybrid engine can include, but are not limited to, a linear electric motor integrated into an internal combustion engine. The integrated linear parallel engine can include a plurality of pistons each having magnetic properties, a plurality of electromagnets, a power supply, and an internal combustion engine. The magnetic pistons can be implemented to act as normal pistons in the internal combustion engine and to act as rotors for the linear electric motor.

### BACKGROUND

The importance of developing technologies that improve fuel economy is both an environmental goal and a financial goal. The automotive industry strongly emphasizes improved fuel economy and strives to research and develop competitive and cost effective fuel-efficient technologies. However, even the most advanced technologies cannot overcome the laws of physics. Thermodynamics states that even an ideal frictionless piston cannot achieve 100% efficiency, as the maximum possible efficiency in an internal combustion engine is restricted by the Charles Carnot theorem, and given by:

$$η \leq 1 - \frac{{T}_{C}}{{T}_{H}}$$

where “η” is the theoretical efficiency, “T_{C}” is the temperature of the combustion chamber at its lowest (after expansion), and “T_{H}” is the temperature of the chamber at its highest (after compression), measured in the Kelvin Temperature scale. For example, in a typical situation with outdoor temperature at 290 Kelvin, and given a combustion temperature for gasoline of 550 Kelvin, the maximum theoretical efficiency of an internal combustion engine would be about 47%. Currently, modern gasoline engines have an average efficiency ranging from 25% to 30% and diesel engines have an average efficiency ranging from 35% to 40%.

The scope of present technologies such as hybrid motors, advanced combustion technologies, and electric drivetrains are promising but the impact of these technologies has not yet been substantial in the marketplace. The hybrid and electric drivetrain is one of the most fuel efficient technologies in existence, but it was featured in approximately 3% of total automobiles sold in 2014 in the US. Part of the reason for this is that hybrid and electric drivetrains have low power output and higher maintenance requirements.

Advanced combustion technologies that deploy methods to improve thermodynamic efficiency, such as gasoline direct injection, learn burn, and common rail engines such as those deployed in Ford Ecoboost have greater market penetration but are not as fuel efficient as hybrid drivetrains.

Parallel hybrid is the most commonly used hybrid technology. Parallel hybrid engines use a combination of an electric motor and a combustion motor connected on a parallel axis. The net torque is the sum of the torque of the motors minus the mechanical linkage (coupling) losses. Parallel hybrid technologies are currently the most compelling and commonly used technology on the market. Parallel hybrids and hybrids in general have not been very successful in the low rpm/high power markets such as the F-250, UPS trucks, semi-trailers, and ground utility vehicles for the defense industry. A vast majority of the previously mentioned vehicles are used in fleets where performance and fuel efficiency are highly important.

Some of the inherent limitations that prevent the practical use of hybrids in high power applications are space and/or power limitations. Electric motors are typically heavy and power consuming. For instance, a 400 bhp vehicle that derives 40% of the power from an electric motor requires a 160 bhp electric motor. A 160 bhp electric motor is heavy and consumes large amounts of power. As such, the supplemental weight of the electric motor and battery increases the work load added to the fact that there is usually a need for a 240 bhp v-8 internal combustion engine. The combined motor greatly increases an overall weight of the vehicle. Further, when including linkage and coupling losses, the hybrid system results in a negligible net increase in fuel economy and performance. Even further, the laws of thermodynamics state that there is always a loss between two non-ideal thermodynamic systems connected together. Essentially this means that any combination of systems, for instance an electric motor and a combustion motor, will have coupling or other mechanical losses.

There has been some research into integrating linear motors in vehicles. Currently, there are very few designs that have been used in commercial hybrid vehicles. One of the greatest limiting factors is that linear motors are not very powerful in applications where there is reciprocating motion.

One recent design includes an electromagnetically accelerated piston used in combination with an internal combustion engine piston. More specifically, the electromagnetically accelerated piston is located in a different cylinder than the pistons of the internal combustion engine. The electromagnetic piston includes placing electromagnets on a top and a bottom of a cylinder of the electromagnetic piston. The electromagnets are placed above and below the piston since a direction must be imparted to the piston. Hence, switching bipolar magnets are placed at the top and the bottom of the cylinder to attract and repel the piston. However due to the physics of electromagnetism, as denoted below:

$$F ∝ \frac{1}{{x}^{2}} \frac{dF}{dx} ∝ \frac{- 2}{{x}^{3}}$$

For every “x” units of distance travelled, the electromagnetic force gradient changes by 10⁻³. The force from the electromagnets becomes exponentially weaker as the further the piston is from each magnet. The recently disclosed design is inefficient and has several flaws. For instance, there is no proper way to time the rpm of the combination engine due to the complexity of expansion timing and crank angle in the different cylinders.

Therefore, there is a need for an engine implementing a linear electric motor within the confines, and in conjunction with, an internal combustion engine that does not include losses due to linkage.

### BRIEF DESCRIPTION OF THE DRAWINGS

FIG. 1A is a cross-sectional view of an integrated linear parallel hybrid engine according to one embodiment of the present invention.

FIG. 1B is a cross-sectional view of a linear electric motor according to one embodiment of the present invention.

FIG. 2 is a cross-sectional view of a magnetic piston according to one embodiment of the present invention.

FIG. 3A is a block diagram of a permanent magnet according to one embodiment of the present invention.

FIG. 3B is a block diagram of a toroidal electromagnet according to one embodiment of the present invention.

FIG. 4 is a block diagram of an integrated linear parallel hybrid engine according to one embodiment of the present invention.

FIG. 5 is a block diagram of an integrated linear parallel hybrid engine according to one embodiment of the present invention.

FIG. 6 is a block diagram of an integrated linear parallel hybrid engine according to one embodiment of the present invention.

FIG. 7 is a block diagram of a top view of an engine block according to one embodiment of the present invention.

FIG. 8A is a graphical illustration of three magnetic pistons moving in an integrated linear parallel hybrid engine according to one embodiment of the present invention.

FIG. 8B is a graphical illustration of three magnetic pistons moving in an integrated linear parallel hybrid engine according to one embodiment of the present invention.

FIG. 9A is a graphical illustration of a permanent magnet showing three theoretical domains according to one embodiment of the present invention.

FIG. 9B is a graphical illustration of a permanent magnet showing coordinate locations according to one embodiment of the present invention.

### DETAILED DESCRIPTION

Embodiments of the present invention include an integrated linear parallel hybrid engine. The ILPH engine can include, but is not limited to, an internal combustion engine and a linear electric motor. The internal combustion engine can typically include an engine block, at least one cylinder, a plurality of valves, and an ignition system. The linear electric motor can include, but is not limited to, a modified piston having magnetic properties, a plurality of electromagnets, and a power supply.

In an internal combustion engine, combustion of a fuel/air mixture can exert a force on a piston and can displace a piston from top dead centre (TDC), or top most position, to bottom dead centre (BDC), or the bottom most position. The linear reciprocating motion can be converted into rotational motion by a crankshaft. Present combustion technologies are concerned with improvements in the interactions of fuel/air mixtures and an expansion of the piston. For example, technologies currently include the Swivel Effect techniques used in many modern Gasoline Direct Injection (GDI) engines create vortices through pits in the piston called swirl cavities to help improve the adiabatic expansion and have a cleaner combustion. Spray atomization of fuel under high pressure and differential intake cycles are used in lean burn technologies to increase efficiency by combusting the gasoline while exceeding the stoichiometric ratio (ratio of the number of moles of air to fuel) of 14.64:1.

In one embodiment, the ILPH engine can include a control module to determine when to supply current to the electromagnets. Generally, the control module can be connected to the power supply and an engine control unit (ECU) typically found in vehicles. As can be appreciated, the control module can receive information from the engine control unit, and based on that information, the control module can send a signal to the power supply to apply a current to the one or more electromagnets. In some embodiments, the control module can be a series of electrical switches that are adapted to turn the power supply on and off. In other embodiments, the control module can implement software to turn the power supply on and off.

Typically, the linear motor can be integrated into the internal combustion engine. For instance, the ILPH engine can implement an electric motor within an existing physical dimensions of an engine block of an internal combustion engine. As can be appreciated, the integrated linear parallel hybrid engine can implement two different energy sources acting in the same thermodynamic system. In one embodiment, the integrated linear parallel hybrid engine can keep all energy in a single system and can integrate a dual propulsion mechanism at each piston included in the internal combustion engine.

Typically, a modified piston can be implemented that includes magnetic properties. For instance, parts of the piston can be magnetized in such a way that it is both compatible with an internal combustion engine and a linear motor. The modified piston can be implemented to act as both a thermal wall of expansion for the internal combustion engine and the electric rotor of the linear motor portion of the ILPH engine. The ILPH engine can directly implement magnetic forces between components having magnetic properties for propulsion of the modified piston. For instance, electromagnetic windings located proximate the modified piston can produce a force acting on the piston armature when current passes through to the electromagnets. It is to be appreciated that since electric motors are rotation per minute (rpm) and load dependant, and have varying peaks and lows, forces from magnetic materials can vary depending on the permeability, amperage, number of turns, and physical shape of the magnetic materials.

The ILPH engine can be independent of a type of combustion cycle of an internal combustion engine. As can be appreciated, the ILPH engine can be compatible with all engines having a reciprocating piston movement. For example, the ILPH engine can be implemented with a diesel engine. When implemented with a diesel engine, the ILPH engine can avoid magnetic impedance during a spark ignition process. In another example, the ILPH engine can be implemented with modern gasoline engines. For instance, most modern gasoline engines have a common rail injection system and usually a spark begins towards an end of the compression stroke at a swirl cavity. Since the spark begins towards an end of the compression stroke, an appropriate electromagnetic timing can be implemented to maximize an additional force provided by the electromagnets on the modified piston.

In one embodiment, the modified piston can essentially be an adiabatic thermal wall of expansion for the internal combustion engine and act as a rotor of a linear motor integrated into the cylinder. Generally, the piston can be designed to integrate a permanent magnet within a body of the piston. For instance, the modified piston can be a combination of a regular piston with a specified magnetized area protected from the combustion process. In one example, the permanent magnet can be manufactured from an Alnico magnet with a Curie temperature of 800° C. In another example, the permanent magnet can be manufactured from a rare earth magnet that includes an alloy of rare earth metals.

In one embodiment, the alnico magnet can be integrated into a skeletal framework of the modified piston. Generally, the skeletal framework can be manufactured from a non-ferromagnetic material. The magnetic area can be divided into three theoretical domain areas, which will be expounded upon hereinafter. In one example, the alnico magnet can have a substantially cuboidal shape with a proportional size hole for receiving a wrist pin and a trenched area in the middle leading up to the wrist pin. A swing of a connecting rod can be through a thickness of the piston in the trenched area. In one instance, the permanent magnet of the piston can be cuboidal in shape. Similar to a standard internal combustion engine, the modified piston can be connected to a crankshaft via the connecting rod.

In one embodiment, the permanent magnet can be covered by an aluminium body and can be jointed via a wrist pin rod. Typically, the rest of the skeletal framework of the piston can be made from non-ferromagnetic materials including, but not limited to, aluminium and magnesium to avoid eddy current build up.

In one embodiment, a coordinate system can be implemented to build and position each of the components of the piston. For instance, a location of the wrist pin and the three theoretical magnetic area domains can be determined based on the coordinate system. The coordinate system can also be used to determine a location for a set of slip rings. The coordinate system can be implemented since a geometry of the piston can affect an interaction of the piston within the internal combustion engine and with the electromagnets.

In one embodiment, the electromagnets can include, but are not limited to, solenoids and/or toroids. In one embodiment, the electromagnets can be installed or placed into a space located between each cylinder located in the engine block. For instance, the space can typically be used for cooling water jackets. In embodiments where the electromagnets are placed inside the space allocated for cooling water jackets, the position of the cooling water jackets can be moved or rotated by 90° to accommodate the electromagnets. In one embodiment, the space between the cylinders can be manufactured to be about an inch thicker than conventional combustion engine designs to accommodate the electromagnets.

In one embodiment, a placement of the electromagnets can be such that the magnetic orientation of each electromagnet can be aligned to provide a push or pull effect on the modified piston as the modified piston travels along a complete length of the cylinder. As can be appreciated, the magnetic orientation of each electromagnet can be determined based on a location of the modified piston in relation to that electromagnet. For instance, the magnetic orientation of the electromagnet can be switched based on whether the electromagnet is closer to a bottom portion of the modified piston or an upper portion of the modified piston to provide either a push effect or pull effect.

In one embodiment, a current applied to the electromagnets by the power supply can be reversed based on piston location sensors and/or one or more Hall Effect sensors. For instance, a voltage reversing circuit can be implemented to change the direction of current flow based on receiving a signal from the piston location sensors or Hall Effect sensors. It is to be appreciated that other means of automatically switching the current are contemplated.

In one example, to reduce net power consumption, the current can be applied only during power strokes of the internal combustion engine. For instance, in a typical V-6 engine, the entire series of top dead centre to bottom dead centre movements are orchestrated in an alternative fashion and when one piston is at the top dead centre location, then a pair of that piston will be at a bottom dead centre position. In such a configuration, one or more switches can be implemented along with one or more piston position sensors to supply a current to electromagnets proximate a piston undergoing a power stroke.

As can be appreciated, the electromagnets in the configuration previously mentioned should be configured such that demagnetization during switching happens fast enough that the motion of the piston from bottom to top is not affected by residual induction present in the electromagnets. Since residual magnetization is dependent on a variety of factors including, but not limited to, temperature, magnetic permeability, and hysteresis losses, a net overall efficiency can be analyzed to determine the optimum time to switch a magnetic orientation of the electromagnets. Alternatively, integrating electromagnets where demagnetization happens sufficiently fast can negate the step of analyzing the overall efficiency.

In one embodiment, if demagnetization effects an overall efficiency, the ILPH engine can include a voltage reversing circuit. The voltage reversing circuit can be implemented to supply a low amperage/high voltage signal to existing electromagnets to reverse magnetic fields more quickly. In another embodiment, the voltage reversing circuit can be implemented to supply a low amperage/high voltage signal to existing electromagnets to demagnetize the electromagnets. For instance, the voltage reversing circuit can be adapted to work almost instantly after the end of a power stroke. As can be appreciated, the time period of the signal is very short. For example, the signal can be supplied for 1/10^{th} a minimum time taken for a piston to travel from bottom dead centre to top dead centre. It is to be appreciated that the voltage reversing circuit can be implemented to demagnetize the electromagnets to reduce any negative forces acting on the modified piston.

As can be appreciated, a distance of poles on the permanent magnet portion of the modified piston can be a constant. For instance, the distance can be defined by:

$${d}_{P} = \frac{r}{\sqrt{2}} + d$$

where “r” is a radius of the modified piston and “d” is a thickness of the cylinder wall plus a thickness of a piston ring.

In one embodiment, an alternating series of electromagnets can be implemented to reduce net power consumed by the engine. For instance, electromagnets can be shared between cylinders since an orientation of two paired pistons are typically opposite to one other.

It is to be appreciated that any previously disclosed piston technique can be added to the modified piston and implemented in the ILPH engine. For instance, swirl cavities, advanced atomization techniques (presuming the components are non-ferromagnetic), and thermally resistant materials can be implemented in the ILPH engine.

A net force acting on the piston can be a summation of combustion forces and a force from the electromagnets minus losses including, but not limited to, friction, heat loss, manufacturing imperfection loss, etc. Electromagnets can be configured to produces varying magnetic fields depending on the shape, relative magnetic permeability of the cores, amperage passing through the wires, length of the magnetic cores etc. The magnetic field is constant. It is to be appreciated that a force between the magnetic piston and the electromagnets can be estimated by the Aaron Gilbert model.

By proportionately reducing the fuel intake and increasing the energy from the magnetic system, a net energy in the ILPH engine can be balanced leading to better fuel economy as an alternative to increased power. For instance, the ILPH engine can add an additional 350 newtons of force per power stroke that can translate to 30% more force for a 402 bhp V-8 turbocharged engine at 5500 rpm. Alternatively, the ILPH engine can provide approximately 30% lesser fuel consumption for the same V-8 engine.

Due to space ergonomics and reduced engine weight increase (e.g., only 10%), the ILPH engine can be efficient and easy to manufacture.

In one instance, the ILPH engine can be a kit adapted to be integrated into an existing internal combustion engine. For instance, the kit can include, but is not limited to, a plurality of pistons having magnetic properties, a power supply, a plurality of electromagnets, a voltage reversing circuit, and a control module. It is to be appreciated that the voltage reversing circuit can be replaced for other similar devices.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “run” and “running,” as used in the specification and the appended claims, refers to when an internal combustion engine is continuously converting chemical energy into mechanical energy. For instance, pistons of an internal combustion engine are moved by a force created from a combustion of an air and fuel mixture, or similar, inside a cylinder of the internal combustion engine. Stated alternatively, the terms refer to when an internal combustion engine is converting a first form of energy into mechanical energy.

### An Embodiment of a Linear Parallel Hybrid Engine

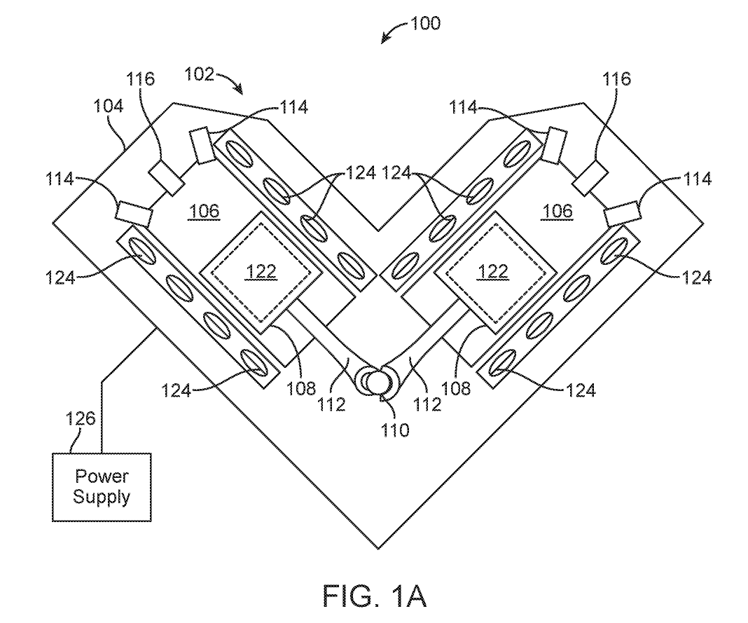

Referring to FIGS. 1A-1B, detailed diagrams of an embodiment 100 showing a linear parallel hybrid (ILPH) engine are illustrated. The ILPH engine 100 can be implemented to provide enhanced power and/or increased fuel efficiency. In some embodiments, a combination of enhanced power and fuel efficiency can be achieved based on how certain components of the ILPH engine 100 are configured.

In one embodiment, the ILPH engine 100 can include an internal combustion engine 102 and a linear electric motor 120. Components of the linear electric motor 120 can be integrated into, and within, an engine block 104 of the internal combustion engine 102, as shown in FIG. 1A. Typically, the linear electric motor 120 can be used simultaneously and in addition to the internal combustion engine 102. For instance, the linear electric motor 120 can be activated when the internal combustion engine 102 is running.

The internal combustion engine 102 can include components commonly found in an internal combustion engine. For instance, the internal combustion engine 102 can include, but is not limited to, the engine block 104, one or more cylinders 106, one or more pistons 108, a crank shaft 110, one or more connecting rods 112, a plurality of valves 114, and an ignition system 116. It is to be appreciated that the components listed are not an exhaustive list and are included to provide a basic explanation of how the linear electric motor 120 interacts with the internal combustion engine 102. It is also to be appreciated that the internal combustion engine shown is for illustrative purposes only and not meant to be limiting. It is to be appreciated that a spark plug can be part of the ignition system 116. Embodiments of the internal combustion engine 102 can include, but are not limited to, four-stroke piston engines, two-stroke cycle engines, rotary engines, and engines generally including pistons.

As shown in FIGS. 1A-1B, the linear electric motor 120 can include, but is not limited to, at least one of the one or more pistons 108 including a magnetic portion 122, a plurality of electromagnets 124, a plurality of boxes 125, and a power supply 126. Typically, the magnetic portion 122 of the piston 108 can act as a rotor and the plurality of electromagnets 124 can act as the stator in the linear electric motor 120. The piston 108 including the magnetic portion 122 can be configured to move within one of the cylinders 106 of the internal combustion engine 102. Hereinafter, the piston 108 including the magnetic portion 122 will be called the modified piston 108. As can be appreciated, the power supply 126 can be electrically connected to each of the plurality of electromagnets 124.

Typically, each cylinder 106 of the internal combustion engine 102 can include a piston having magnetic properties and a set of electromagnets. For instance, in a six cylinder engine, there can be six magnetic pistons, at least eight sets of electromagnets, and a power supply. The magnetic pistons can be constructed to fit within the cylinders of the six cylinder engine. It is to be appreciated that embodiments are contemplated where less than all of the pistons of a particular engine include a magnetic portion.

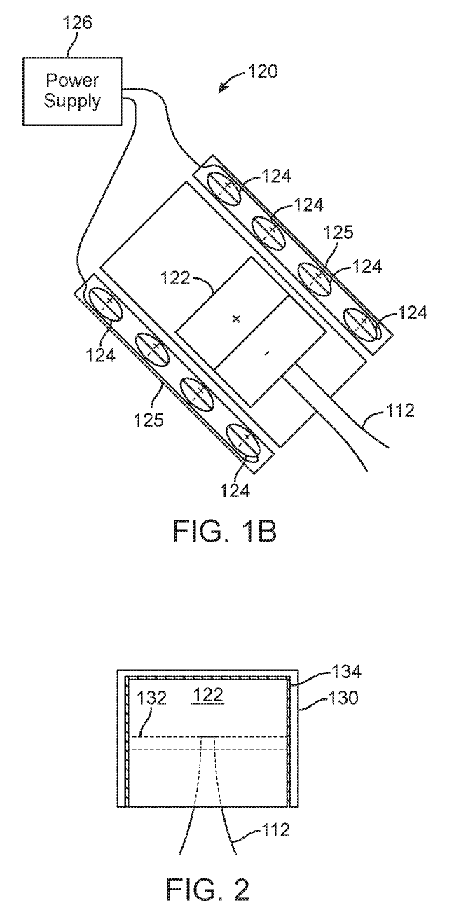

As shown in FIG. 2, the modified piston 108 can typically include the magnetic portion 122, an outer casing 130, and a wrist pin 132. In one embodiment, the magnetic portion 122 can be a permanent magnet. Generally, the permanent magnet 122 can be coupled to the outer casing 130 and the wrist pin 132. For instance, the permanent magnet 122 can be jointed to the outer casing 130 via the wrist pin 132. The wrist pin 132 can be coupled to one of the connecting rods 112 of the internal combustion engine 102. As can be appreciated, the permanent magnet 122 can be manufactured to include a space for the connecting rod 112 to move through.

Typically, the permanent magnet 122 can have a cuboidal shape. It is to be appreciated that the permanent magnet 122 can have different shapes depending on the type of internal combustion engine the linear electric motor 120 is being integrated into. For instance, a size and shape of the permanent magnet 122 can be based on a size of cylinders of the internal combustion engine. As will be discussed hereinafter, an innovative coordinate system can be implemented to determine a size of the permanent magnet 122 based on a size of a piston being replaced or modified in a particular engine.

The power supply 126 can include, but is not limited to, a fuel cell, an electrical vehicle battery, a traction battery, a rechargeable energy storage system (RESS), and other electrical power supplies known to one of ordinary skill in the art. Generally, the power supply 126 can provide an electrical current of approximately 0.1 amperes to 10 amperes to each of the electromagnets 124. In one embodiment, the power supply 126 can provide an electrical current of approximately 0.8 amperes to 4.0 amperes to each of the electromagnets 124. It is to be appreciated that the electrical current provided can be load dependent.

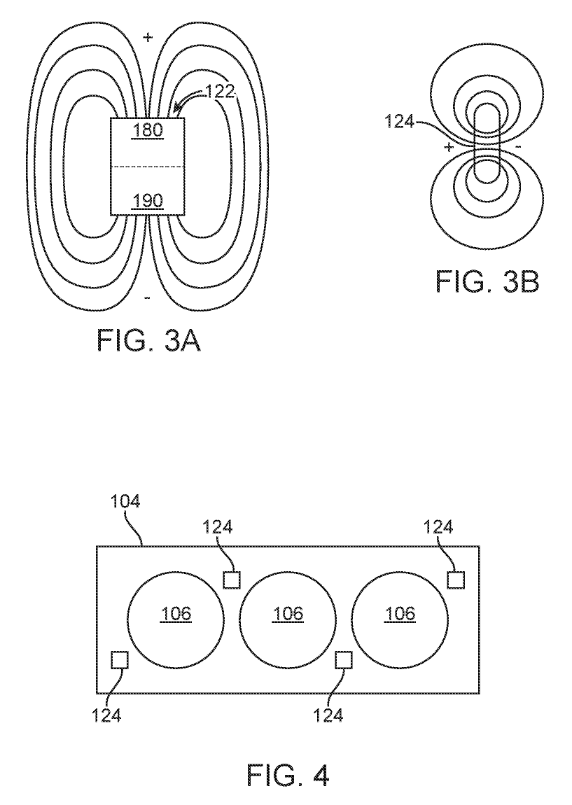

Referring to FIG. 3A, a block diagram of the permanent magnet 122 is illustrated showing a positive pole 180 and a negative pole 190 of the permanent magnet 122. A shown, the positive pole 180 is located approximate an upper portion of the permanent magnet 122 and the negative pole 190 is located approximate a lower portion of the permanent magnet 122. As can be appreciated, the poles 180, 190 of the permanent magnet 122 can be switched where the positive pole 180 is approximate the bottom portion and the negative pole 190 is approximate the upper portion of the permanent magnet 122.

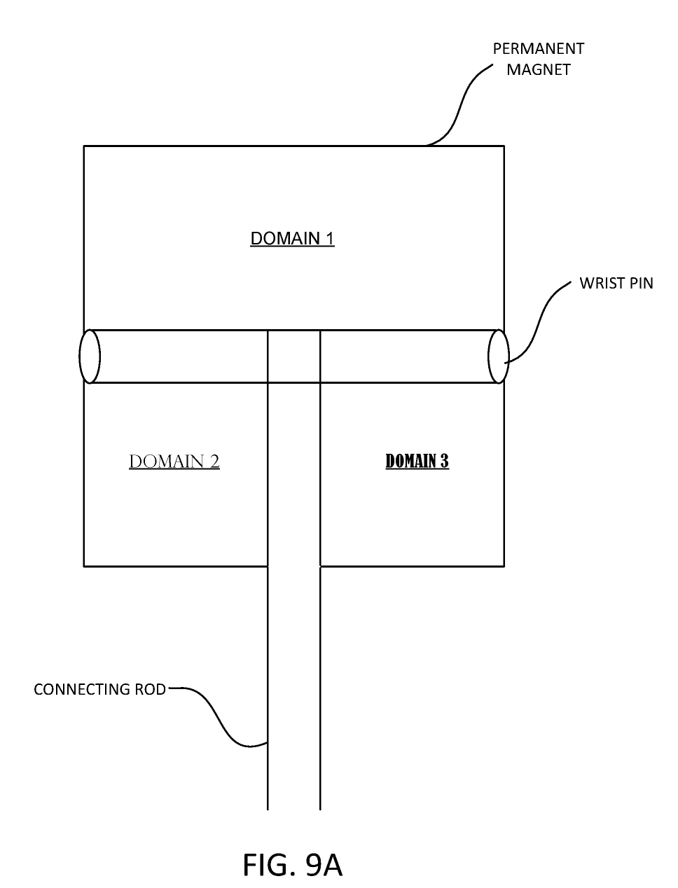

Referring to FIG. 3B, a block diagram of one of the electromagnets 124 is illustrated showing a positive pole 180 and a negative pole 190. Of note, the positive pole 180 and the negative pole 190 are located on sides of the electromagnet 124. As can be appreciated, the magnetic force of the electromagnet 124 can be directed towards and away from the permanent magnet 122, as shown in FIGS. 8A and 8B. As will be discussed hereinafter, one set of electromagnets 124 can be implemented to effect two different pistons.

As shown in FIG. 1B, the plurality of electromagnets 124 can be placed in the boxes 125. In one embodiment, the boxes 125 can be sized to fit into cooling water jackets commonly found in engine blocks. As can be appreciated, a size of the boxes 125 will be dependent on the number of electromagnets 124 to be implemented and a size of the cooling water jackets in a particular engine.

Referring back to FIG. 2, in some embodiments, the modified piston 108 can include an aerogel 134 located between the permanent magnet 122 and the outer casing 130. Typically, the aerogel 134 can be implemented between the permanent magnet 122 and the outer casing 130 to provide thermal protection to the permanent magnet 122. It is to be appreciated that well known aerogels can be implemented. In some embodiments, materials having similar properties to aerogels can be implemented. In embodiments where rare earth magnets are implemented, the aerogel 134 can be implemented to protect the rare earth magnets from heat generated during combustion of fuel/air mixtures of the internal combustion engine.

It is to be appreciated that a configuration of an internal combustion engine will generally dictate which process described hereinafter is implemented to determine when to power the electromagnets 124. Further, the internal combustion engine configuration will typically dictate where the electromagnets 124 are placed in relation to the cylinders of a particular internal combustion engine.

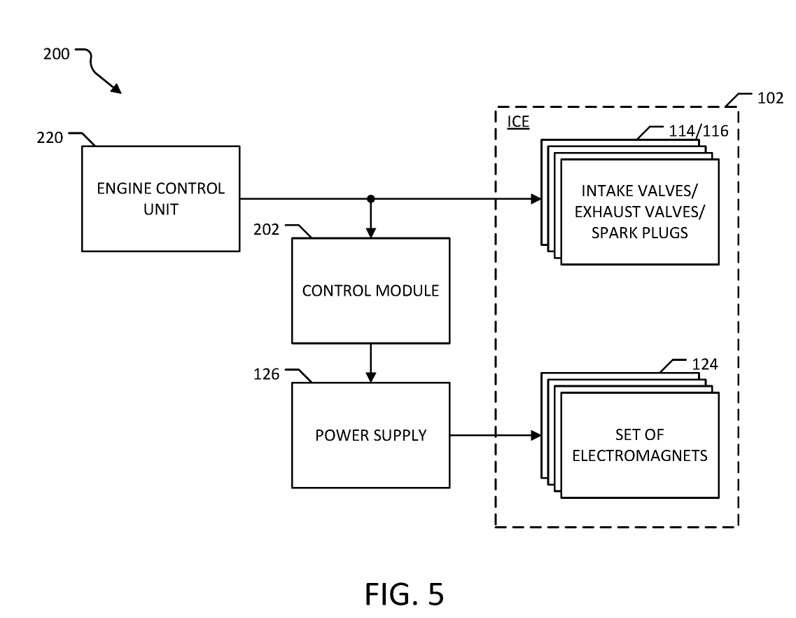

For instance, for a V-6 configuration where three cylinders are located on either side of an engine block, the electromagnets 124 can generally be placed on opposing sides of each cylinder, as shown in FIG. 4. As shown, the location of the electromagnets 124 allows the middle cylinder to share electromagnets with the outside cylinders. Generally, the middle cylinder can be located at bottom dead centre when the outside cylinders are located at top dead centre and vise versa. It is to be appreciated that the electromagnets 124 located between the outside cylinders and the middle cylinders can positively affect the pistons located in each of the cylinders, as will be discussed hereinafter.

### A First Embodiment of an Integrated Linear Parallel Hybrid Engine System

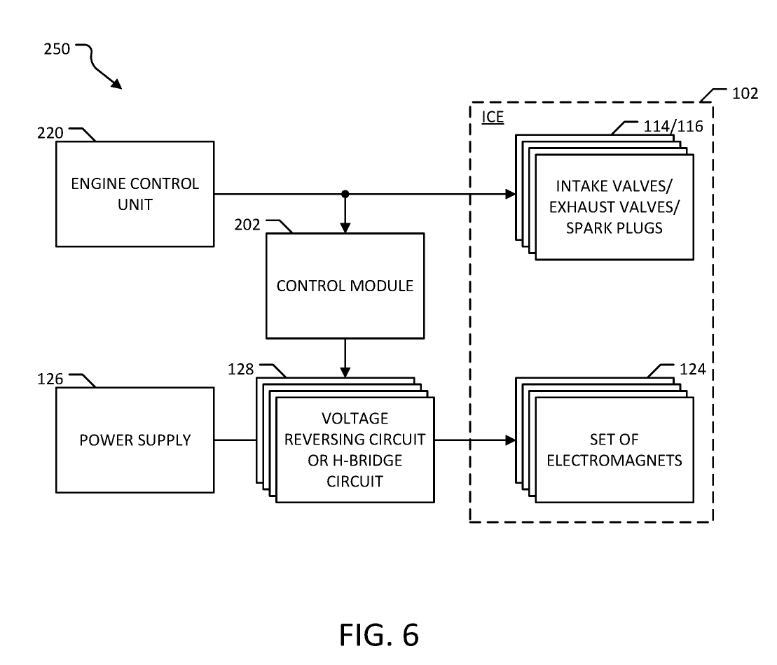

Referring to FIG. 5, a block diagram of a first embodiment 200 of an integrated linear parallel hybrid (ILPH) engine system is shown. The ILPH engine system 200 can be implemented to provide additional power and/or greater fuel efficiency to a standard internal combustion engine.

As shown, the first embodiment ILPH engine system 200 can include, but is not limited to, the previously discussed components of the internal linear parallel hybrid engine 100, a control module 202, and an engine control unit (ECU) 220.

Generally, the control module 202 can be implemented to control components of the linear electric motor 120 during operation of the internal combustion engine 102. In one instance, the control module 202 can be implemented to determine when to provide an electrical current to the plurality of electromagnets 124 based indirectly on a location of a particular modified piston 108. Stated alternatively, the control module 202 can be implemented to determine when to provide current to the plurality of electromagnets 124 based on the plurality of valves 114 and the ignition system 116. Generally, each of the modified pistons 108 can include at least one set of electromagnets 124.

In a typical implementation, the control module 202 can receive a signal from the ECU 220 when the ECU 220 is sending a signal to one of the plurality of valves 114 and the ignition system 116. Generally, the signal can include, but is not limited to, when the plurality of valves 114 are to be opened and closed and when the ignition system 116 is to activate a spark plug. As can be appreciated, the plurality of valves 114 can include, but are not limited to, intake valves and exhaust valves.

Typically, the intake valves and the exhaust valves can be opened and closed based on which stroke a piston is completing in a typical four-stroke engine. For instance, during a first or intake stroke, the intake valves can be opened to allow an air-fuel mixture to enter the cylinder. During a second or compression stroke, all of the valves can remained closed. During the third or power stroke, all of the valves can remained closed and the ignition system 116 can activate a spark plug to create a power stroke. During a fourth or exhaust stroke, the exhaust valve can be opened and the intake valve can remain closed.

In one example, a set of electromagnets 124 proximate a modified piston 108 undergoing a power stroke can be activated by the control module 202. Generally, the control module 202 can receive information from the engine control unit indicating when a spark plug is activated for each cylinder. When the control module 202 determines that a spark plug has been activated, the control module 202 can send a signal to the power supply 126 to apply a current to a set of electromagnets 124 interfacing with the modified piston 108 whose spark plug was activated. As each spark plug of the internal combustion engine is activated, the control module 202 can send a signal to the power supply 126 to apply a current to the sets of electromagnets 124 interfacing with the modified piston 108 whose spark plug was activated.

Typically, the first embodiment ILPH engine system 200 can be implemented in instances where the electromagnets are used only during a power stroke of a piston. As can be appreciated, the electromagnets should be configured such that demagnetization happens fast enough that the motion of the piston from bottom to top is not affected by residual induction present in the electromagnets after the power stroke.

### A Second Embodiment of an Integrated Linear Parallel Hybrid Engine System

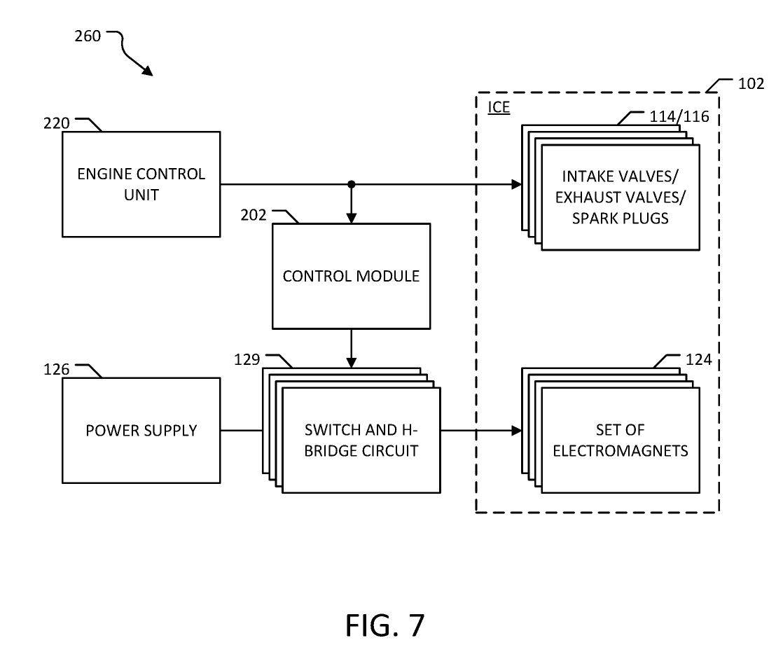

Referring to FIG. 6, a block diagram of a second embodiment 250 of an integrated linear parallel hybrid (ILPH) engine system is shown. The ILPH engine system 250 can be implemented to provide additional power and/or greater fuel efficiency to a standard internal combustion engine.

As shown, the second embodiment ILPH engine system 250 can include, but is not limited to, the previously discussed components of the internal linear parallel hybrid engine 100, a plurality of voltage reversing circuits 128, the control module 202, and the engine control unit (ECU) 220. Generally, the ILPH engine system 250 can include a voltage reversing circuit 128 for each modified piston 108 of the ILPH engine 100.

Generally, the second embodiment ILPH engine system 250 can be implemented when the electromagnets 124 are to be activated during each stroke of the modified piston 108. As can be appreciated, the power supply 126 can be adapted to supply a constant electric current to each set of electromagnets 124. The voltage reversing circuits 128 can be implemented to reverse the electrical current to the electromagnets 124.

As previously described, the control module 202 can receive information from the ECU 220 indicating when the plurality of valves 114 are opened and closed and when the ignition system 116 has been activated. Typically, the control module 202 can determine when to activate the voltage reversing circuit 128 based on which stroke a particular modified piston is undergoing. In one embodiment, the control module 202 can receive signals sent from the ECU 220 to each of the valves 114 and the ignition system 116. Based on receiving those signals, the control module 202 can determine when to have the voltage reversing circuit 128 reverse the flow of current to a particular set of electromagnets 124. It is to be appreciated that the control module 202 can send signals to each of the voltage reversing circuits 128 for each set of electromagnets 124.

For illustrative purposes only, an example is provided hereinafter that describes a four-stroke cycle for a single magnetic piston. It is to be appreciated the example described hereinafter can be applied for each magnetic piston in an internal combustion engine.

At a start of the intake stroke, the modified piston 108 would be located at top dead centre location and an intake valve would be open. The control module 202 can then power a set of electromagnets 124 interfacing with the modified piston 108 moving in a downwards direction. For instance, the control module 202 can receive a signal sent from the ECU 220 to the intake valve to activate the intake valve. The control module 202 can then determine that the modified piston 108 is in an intake stroke.

During the compression stroke, the intake valve and the exhaust valve would both be closed and the modified piston 108 would be moving in an upwards direction. In response to determining that the modified piston 108 is in the compression stroke, the control module 202 can send a signal to the voltage reversing circuit 128 to reverse the electrical current supplied to the set of electromagnets 124 for the upward movement of the modified piston 108. By reversing the electrical current, the set of electromagnets 124 can reverse polarity.

During the power stroke, the control module 202 can determine that a spark plug has been activated and the valves are all closed. Since the modified piston 108 would be starting from the top dead centre position and in a downward direction, the control module 202 can send a signal to the voltage reversing circuit 128 to reverse back. The electromagnets 124 can then be aligned for the modified piston 108 moving in a downward direction.

The control module 202 can determine that the modified piston 108 is in the exhaust stroke by receiving information from the engine control unit that the exhaust valve is open. During the exhaust stroke, the modified piston 108 can be starting from bottom dead centre location and move in an upward direction. The control module 202 can send a signal to the voltage reversing circuit 128 to reverse the current supplied to the electromagnets 124, similar to the compression stroke.

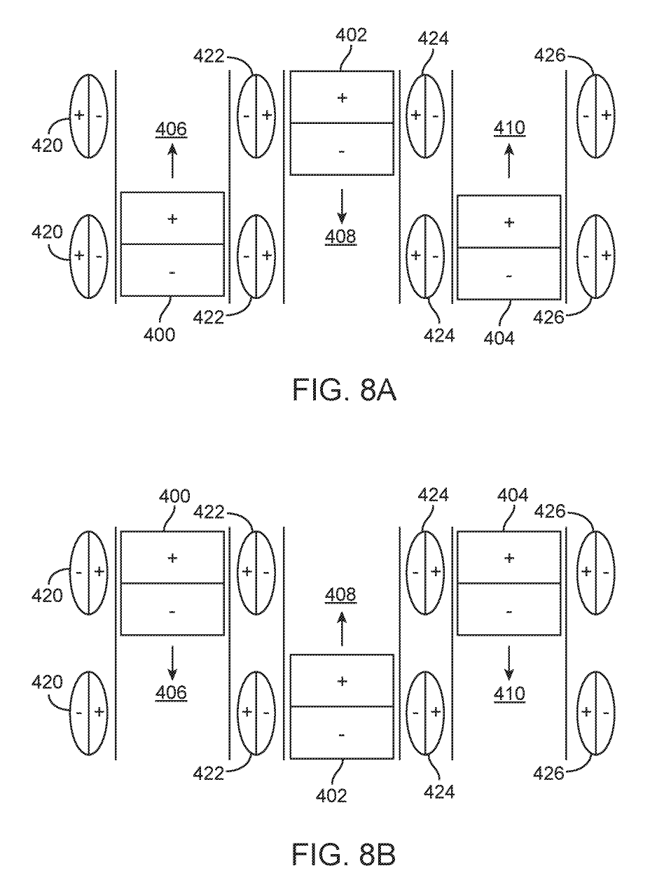

Referring to FIG. 7, a block diagram of a third embodiment 260 of an integrated linear parallel hybrid (ILPH) engine system is shown. The ILPH engine system 260 can be implemented to provide additional power and/or greater fuel efficiency to a standard internal combustion engine. The third embodiment ILPH engine system 260 can be substantially similar to the second embodiment ILPH engine system 250.

Generally, the third embodiment ILPH engine system 260 can include a circuit 129 including a well known switch in the art and an H-bridge switch. The circuit 129 can be implemented similar to the voltage reversing circuit 129. For instance, the circuit 129 can be implemented to supply a positive voltage and a negative voltage to a particular set of electromagnets 124.

### An Example Implementation of the Integrated Linear Parallel Hybrid Engine

Referring to FIGS. 8A-8B, detailed diagrams of one example of how the electromagnets 124 can interact with the modified pistons 108 of the ILPH engine 100 are illustrated. For illustrative purposes only, one side of a V-6 engine is shown in FIGS. 8A-8B. As shown, the electromagnets 124 can be adapted to switch polarities depending on whether the electromagnet is closer to a north pole 180 or a south pole 190 of the modified piston 108.

As shown in FIG. 8A, a first magnetic piston 400, a second magnetic piston 402, and a third magnetic piston 404 can be located within respective engine block cylinders 406, 408, 410. The first magnetic piston 400 and the third magnetic piston 404 can be located at bottom dead centre locations in the respective engine block cylinders 406, 410. The second magnetic piston 402 can be located at top dead centre of the middle engine block cylinder 408.

Further illustrated are four sets of electromagnets. A first set of electromagnets 420 and a second set of electromagnets 422 can interact with the first magnetic piston 400. The second set of electromagnets 422 and a third set of electromagnets 424 can interact with the second magnetic piston 402. The third set of electromagnets 424 and a fourth set of electromagnets 426 can interact with the third magnetic piston 404. The sets of electromagnets 420, 422, 424, 426 can be implemented to apply a force to the magnetic pistons 400, 402, 404. A top portion of each of the magnetic pistons will be considered north pole or positive pole and the bottom portion of each of the magnetic pistons will be considered the south pole or negative pole. Each of the electromagnets and magnetic pistons has been labeled either “+” to denote a north pole or “−” to denote a south pole.

For illustrative purposes only, the first magnetic piston 400 and the third magnetic piston 404 can be moving up and the second magnetic piston 402 can be moving down in FIG. 8A. As shown, the first set of electromagnets 420 and the second set of electromagnets 422 can each have the negative pole closest to the first magnetic piston 400. As can be appreciated, the bottom electromagnet of each set of electromagnets 420, 422 can push or repel the bottom portion of the first magnetic piston 400 and the top electromagnet of each set of electromagnets 420, 422 can attract or pull the top portion of the magnetic piston 400. As such, the first set of electromagnets 420 and the second set of electromagnets 422 can provide a push effect and a pull effect on the first magnetic piston 400.

Now looking at the second magnetic piston 402, the second set of electromagnets 422 and the third set of electromagnets 424 can each have the positive pole closest to the second magnetic piston 402. As can be appreciated, a bottom electromagnet of each set of electromagnets 422, 424 can attract or pull the bottom portion of the second magnetic piston 402. A top electromagnet of each set of electromagnets 422, 424 can each push or repel a top portion of the second magnetic piston 402. As such, the second set of electromagnets 422 and the third set of electromagnets 424 can provide a push effect and a pull effect on the second magnetic piston 402.

Now looking at the third magnetic piston 404, the third set of electromagnets 424 and the fourth set of electromagnets 426 can each have the negative pole closest to the third magnetic piston 404. As can be appreciated, a bottom electromagnet of each set 424, 426 can repel or push the bottom portion of the third magnetic piston 406. A top electromagnet of each set 424, 426 can each attract or pull a top portion of the third magnetic piston 404. As such, the third set of electromagnets 424 and the fourth set of electromagnets 426 can provide a push and pull effect on the third magnetic piston 404.

Now referring to FIG. 8B, the first magnetic piston 400 and the third magnetic piston 404 are located at top dead centre and the second magnetic piston 402 is located at bottom dead centre. Once each of the pistons have reached bottom or top dead centre, the voltage reversing circuit can be activated and each of the electromagnets can switch polarities. In one example, the control module 202 can receive data from the piston location sensors 222 indicating that the magnetic pistons have reached top dead centre and bottom dead centre. In another example, the control module 202 can activate the voltage reversing circuit 128 based on determining a status of the plurality of valves 114 and the ignition system 116 for each piston.

As can be appreciated, the first set of electromagnets 420, the second set of electromagnets 422, the third set of electromagnets 424, and the fourth set of electromagnets 426 can each switch polarity when the voltage reversing circuit 128 reverses the flow of current.

As shown, when the first magnetic piston 400 is at top dead centre, the first set of electromagnets 420 and the second set of electromagnets 422 can switch polarity with the positive pole now closest to the piston. The second set of electromagnets 422 and the third set of electromagnets 424 can have the negative pole closest to the second magnetic piston 402. The third set of electromagnets 424 and the fourth set of electromagnets 426 can have the positive pole closest to the third magnetic piston 404.

### A Method of Implementing a Coordinate System for Construction of a Piston

A method or process for implementing a coordinate system to position components of a piston is described hereinafter. Typically, the coordinate system can be implemented to determine a size of the permanent magnet and a relation of the magnetic piston to the wrist pin. Generally, the coordinate system can be based on a size of the piston and map three theoretical domain locations of the permanent magnet. As can be appreciated, a size of a piston implemented in the integrated linear parallel hybrid engine 100 can be dependent on torque and power requirements.

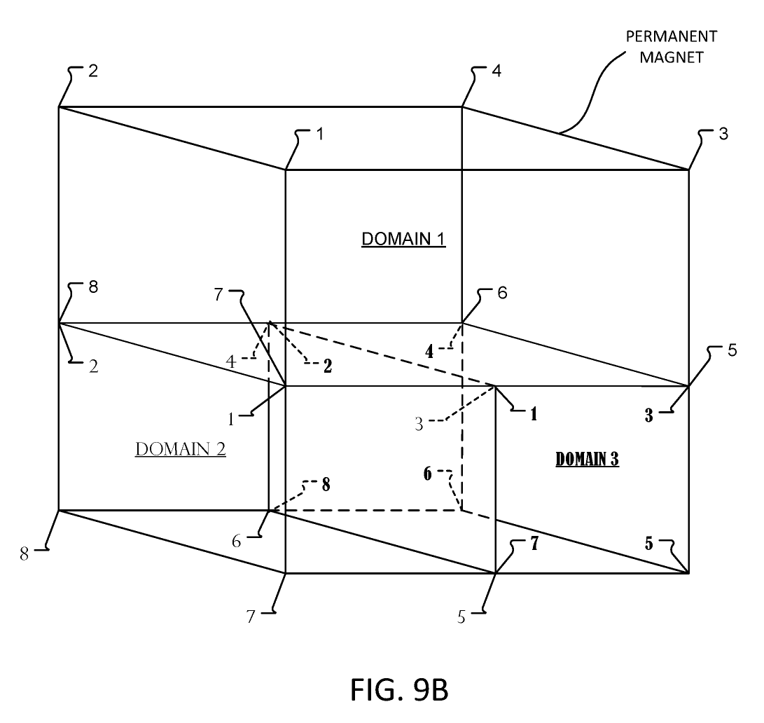

Referring to FIG. 9A, a permanent magnet, a wrist pin, and a connecting rod are illustrated. As shown in FIG. 9A, the first domain can be located above the wrist pin, the second domain can be located below the wrist pin and to the left of a connecting rod, and the third domain can be located below the wrist pin and to the right of the connecting rod. It is to be appreciated that FIG. 9A is provided for illustrative purposes only and is not meant to be limiting.

Referring to FIG. 9B, a cube is illustrated showing the first domain, the second domain, and the third domain. The first domain, the second domain, and the third domain can each be defined by eight coordinate points, described hereinafter. FIG. 9B further shows where each of the eight coordinates are for each of the domains. Generally, the coordinate system can have an origin located at a center of a top of a piston.

For a piston having a radius “r” and a height “k,” a constant d can be created where:

$$d = \frac{k}{8} units .$$

For purposes of the coordinate system, the permanent magnet 122 of the piston 108 can be divided into three domains. A first domain can be located above the wrist pin 132, a second domain can be located below the wrist pin 132 and to the left of the connecting rod 112, and a third domain can be located below the wrist pin 132 and to the right of the connecting rod 112. The coordinate system can be implemented to determine a size and location of each of the three domains of the permanent magnet inside a piston given a piston radius and piston height.

Generally, based on a height and a radius of a particular piston, a manufacturer can determine precise dimensions for a permanent magnet to be implemented in the piston.

Based on an origin of the coordinate system being located at (0, 0d, 0) for an x, y, z coordinate system, and a piston having a height ‘k’ and a radius ‘r’, where d=k/8, coordinates for the first domain, the second domain, and the third domain can be:

Domain 1:
1=(−0.45r\sqrt{2}, 0, 0.45r\sqrt{2})
2=(−0.45r\sqrt{2}, 0, −0.45r\sqrt{2})
3=(0.45r\sqrt{2}, 0, 0.45r\sqrt{2})
4=(0.45r\sqrt{2}, 0, −0.45r\sqrt{2})
5=(0.45r\sqrt{2}, −2.5d, 0.45r\sqrt{2})
6=(0.45r\sqrt{2}, −2.5d, −0.45r\sqrt{2})
7=(−0.45r\sqrt{2}, −2.5d, 0.45r\sqrt{2})
8=(−0.45r\sqrt{2}, −2.5d, −0.45r\sqrt{2})

Domain 2:
1=(0.45r\sqrt{2}, −5.5d, 0.45r\sqrt{2})
2=(0.45r\sqrt{2}, −5.5d, −0.45r\sqrt{2})
3=(0.1r, −5.5d, 0.45r\sqrt{2})
4=(−0.1r, −5.5d, −0.45r\sqrt{2})
5=(−0.1r, −8d, 0.45r\sqrt{2})
6=(−0.1r, −8d, −0.45r\sqrt{2})
7=(−0.45r\sqrt{2}, −8d, 0.45r\sqrt{2})
8=(−0.45r\sqrt{2}, −8d, −0.45r\sqrt{2})

Domain 3:
1=(0.1r, −5.5d, 0.45r\sqrt{2})
2=(0.1r, −5.5d, −0.45r\sqrt{2})
3=(0.45r\sqrt{2}, −5.5d, 0.45r\sqrt{2})
4=0.45r\sqrt{2}, −5.5d, −0.45r\sqrt{2})
5=(0.45r\sqrt{2}, −8d, 0.45r\sqrt{2})
6=(0.45r\sqrt{2}, −8d, −0.45r\sqrt{2})
7=(0.1r, −8d, 0.45r\sqrt{2})
8=(0.1r, −8d, −0.45r\sqrt{2})

As can be appreciated, the previously mentioned coordinates can be implemented to determine a size of a permanent magnet for use in a variety of differently sized pistons currently found in internal combustion engines. The three domains provide dimensions for the permanent magnet based on a radius and height of a particular piston. As such, a size for the permanent magnet 122 can be determined based on a piston size of a particular engine. For instance, the coordinate system can be implemented to determine a size of a permanent magnet for any internal combustion engine using pistons in cylinders.

### ALTERNATIVE EMBODIMENTS AND VARIATIONS

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A hybrid engine comprising:
an internal combustion engine, the internal combustion engine including:
at least one cylinder; and
a piston located within the at least one cylinder, the piston including a permanent magnet;
wherein the internal combustion engine is adapted to run;
a linear electric motor, the motor including:
a plurality of electromagnets located proximate a side and along a length of the at least one cylinder; and
a power supply for applying an electric current to the plurality of electromagnets, the electric current being applied to the plurality of electromagnets as the internal combustion engine runs.

2. The hybrid engine of claim 1, wherein each of the plurality of electromagnets are selected from a group consisting of a toroid electromagnet and a solenoid electromagnet.

3. The hybrid engine of claim 2, wherein poles of the plurality of electromagnets are oriented substantially perpendicular in relation to poles of the permanent magnet.

4. The hybrid engine of claim 1, wherein the electromagnets are adapted to flip polarities depending on where the piston is located in the at least one cylinder.

5. The hybrid engine of claim 1, wherein the linear electric motor further includes a current reverser.

6. The hybrid engine of claim 6, wherein the current reverser is activated based on a stroke of the piston.

7. The hybrid engine of claim 1, wherein the power supply applies the electric current during a power stroke of the internal combustion engine.

8. The hybrid engine of claim 1, wherein the piston includes an exterior shell manufactured from a non-ferromagnetic material.

9. The hybrid engine of claim 9, wherein an aerogel is placed between the exterior shell and the permanent magnet.

10. The hybrid engine of claim 1, wherein the plurality of electromagnets are placed in a water jacket of the internal combustion engine.

11. A hybrid engine comprising:
an internal combustion engine having a plurality of cylinders; and
a linear electric motor integrated into the internal combustion engine, the linear electric motor including:
a piston located inside each of the plurality of cylinders, each piston having a permanent magnet;
a set of electromagnets located proximate a side and along a length of each of the plurality of cylinders; and
a power supply adapted to apply a current to each set of electromagnets;
wherein the linear electric motor is activated when the internal combustion engine is running.

12. The hybrid engine of claim 11, wherein the power supply applies the current to at least one set of electromagnets when the linear electric motor is activated.

13. The hybrid engine of claim 12, wherein the power supply applies the current to a set of electromagnets proximate a piston undergoing a power stroke.

14. The hybrid engine of claim 11, wherein the linear electric motor includes a current reverser.

15. The hybrid engine of claim 14, wherein the current reverser switches the polarity of each set of electromagnets.

16. The hybrid engine of claim 11, wherein each set of electromagnets is connected to a current reverser.

17. A method of using the hybrid engine of claim 11, the method comprising:
providing the hybrid engine;
starting the internal combustion engine; and
applying a current to the plurality of electromagnets while the internal combustion engine is running.

18. The method of claim 17, wherein the current is applied to the plurality of electromagnets proximate a piston undergoing a power stroke.

19. The method of claim 17, further comprising the step of:
reversing the current applied to the plurality of electromagnets.

20. A hybrid engine system comprising:
an internal combustion engine, the internal combustion engine including:
at least one cylinder;
a piston located within the at least one cylinder, the piston including a permanent magnet core and a non-ferromagnetic shell;
a linear electric motor, the motor including:
a plurality of electromagnets located proximate a side and along a length of the at least one cylinder; and
a power supply for applying an electric current to the plurality of electromagnets;
a control module adapted to determine when the power supply applies an electric current to the plurality of electromagnets;
wherein the electric current is applied to the plurality of electromagnets as the internal combustion engine runs.
